(19) United States
(12) Patent Application Publication
(10) Pub. No.: US 2008/0109261 A1
(43) Pub. Date: May 8, 2008

(54) Method and apparatus for providing information, and computer product

(75) Inventors: Kazukiyo Kobayashi, Kawasaki (JP); Yuuji Yokogaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/896,294

(22) Filed: Aug. 30, 2007

(30) Foreign Application Priority Data
Nov. 6, 2006 (JP) 2006-300726

(51) Int. Cl. G06F 19/00

(52) U.S. Cl. 705/3

(57) ABSTRACT

An information providing apparatus includes an updating unit that updates an electronic medical chart of a patient; an acquiring unit that acquires information identifying contents of diagnosis and treatment recorded on the updated electronic medical chart; an authenticating unit that authenticates the patient based on the acquired information and information identifying contents of diagnosis and treatment that is sent from a communication terminal of the patient; and a sending unit that sends the updated electronic medical chart to the communication terminal when the patient is authenticated at the authenticating.

### CROSS-REFERENCE TO RELATED APPLICATIONS

This application is based upon and claims the benefit of priority from the prior Japanese Patent Application No. 2006-300726, filed on Nov. 6, 2006, the entire contents of which are incorporated herein by reference.

### BACKGROUND OF THE INVENTION

1. Field of the Invention

The present invention relates to an information providing technology in which user authentication is carried out.

2. Description of the Related Art

Recently, there is an increasingly higher demand for reviewing medical charts possessed by medical institutions and it is conceivable that the medical charts, etc. of medical institutions will be disclosed to patients in future. In disclosing such private information by way of a network, commonly used authentication by a password is not sufficient. For this reason, a technology is disclosed of authenticating by use of biometric data acquired by a biometric data acquiring device installed in a user terminal (for example, Japanese Patent Laid-Open Publication No. 2002-132932).

In the conventional technology of the above patent application, a testing institution sends the private information together with an identification number upon completion of acquiring private information to a private information custody service institution. The private information custody service institution compares the presented biometric data with the biometric data in custody when requested to disclose the private information by a private person with the presentation of biometric data, and if both data match, discloses the private information.

In the conventional technology described above, however, there arises a problem that a user terminal must be equipped with a biometric data acquiring device, the cost of the user terminal becomes high, and economic burden on the user becomes greater. There also arises a problem that the conventional technology lacks universality in that the user using a user terminal without the biometric data acquiring device can not receive the information provided. Therefore, versatility is poor and the private information is disclosed only for users using the user terminal with the biometric data acquiring device.

Biometric data besides the electronic health record of patients is registered in a server. Because of the unchangeable nature of the biometric data, if the biometric data is divulged, the data must be replaced with biometric data on another part of the human body. For example, when registered iris data is divulged, the iris data can not be modified; therefore, a large scale system change is forced to take place such as changing to fingerprint data. For this reason, there arises a problem that operational cost of the information providing service increases.

### SUMMARY OF THE INVENTION

It is an object of the present invention to at least solve the above problem in the conventional technologies.

A computer-readable recording medium according to one aspect of the present invention stores therein an information providing program causing a computer to execute updating an electronic medical chart of a patient; acquiring information identifying contents of diagnosis and treatment recorded on the updated electronic medical chart; authenticating the patient based on the acquired information and information identifying contents of diagnosis and treatment that is sent from a communication terminal of the patient; and sending the updated electronic medical chart to the communication terminal when the patient is authenticated at the authenticating.

An information providing apparatus according to another aspect of the present invention includes an updating unit that updates an electronic medical chart of a patient; an acquiring unit that acquires information identifying contents of diagnosis and treatment recorded on the updated electronic medical chart; an authenticating unit that authenticates the patient based on the acquired information and information identifying contents of diagnosis and treatment that is sent from a communication terminal of the patient; and a sending unit that sends the updated electronic medical chart to the communication terminal when the patient is authenticated at the authenticating.

An information providing method according to still another aspect of the present invention includes updating an electronic medical chart of a patient; acquiring information identifying contents of diagnosis and treatment recorded on the updated electronic medical chart; authenticating the patient based on the acquired information and information identifying contents of diagnosis and treatment that is sent from a communication terminal of the patient; and sending the updated electronic medical chart to the communication terminal when the patient is authenticated at the authenticating.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an information providing system according to embodiments of the present invention;

FIG. 2 is a schematic of a computer apparatus shown in FIG. 1;

FIG. 3 is an explanatory diagram of contents stored in an electronic medical chart DB;

FIG. 4 is a block diagram of the information providing apparatus;

FIG. 5 is a schematic illustrating a request screen for an electronic medical chart;

FIG. 6 is a schematic illustrating a display screen of inquiring information on a communication terminal of a patient;

FIG. 7 is a schematic illustrating the electronic medical chart displayed on the communication terminal when the patient is authenticated;

FIG. 8 is a schematic illustrating an authentication failure information screen displayed on the communication terminal when the patient is not authenticated;

FIG. 9 is a flowchart of an electronic medical chart generating/updating process by the information providing apparatus; and

FIG. 10 is a flowchart of an information providing process by the information providing apparatus.

FIG. 11 is a flowchart of the information processing according to the invention.

### DETAILED DESCRIPTION OF THE PREFERRED EMBODIMENTS

Exemplary embodiments according to the present invention are explained below in detail with reference to accompanying drawings.

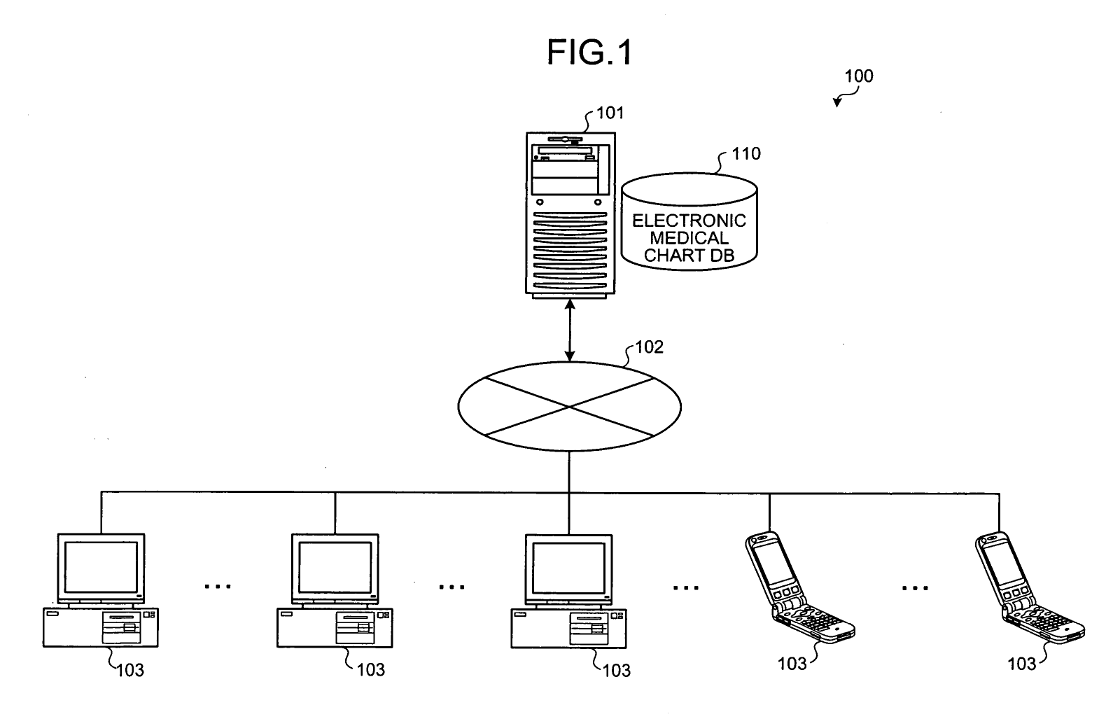

FIG. 1 is a schematic of an information providing system according to embodiments of the present invention. As shown in FIG. 1, the information providing system 100 includes an information providing apparatus 101 serving as a server and a communication terminal 103 of a patient, connected to each other for mutual communication through a network 102 such as the Internet and a cellular phone network. The information providing apparatus 101 is a computer apparatus having an electronic medical chart DB 110. The electronic medical chart is digitized information of the medical chart recording the condition of disease, treatment, course of disease, etc., of the patient and medical charts are separately registered for respective patients. Details of the electronic medical chart DB 110 will be described later.

The information providing apparatus 101 is installed in medical institutions such as hospitals and clinics. The information providing apparatus 101 may be a higher-class server connected to computer terminals of other hospitals and clinics by way of the network 102.

The communication terminal 103 is a computer used by the patient and is equipped with a communication function using the network 102 and a browser function of displaying the information on a display. The communication terminal 103 may be a personal computer, or a cellular phone, owned by the patient.

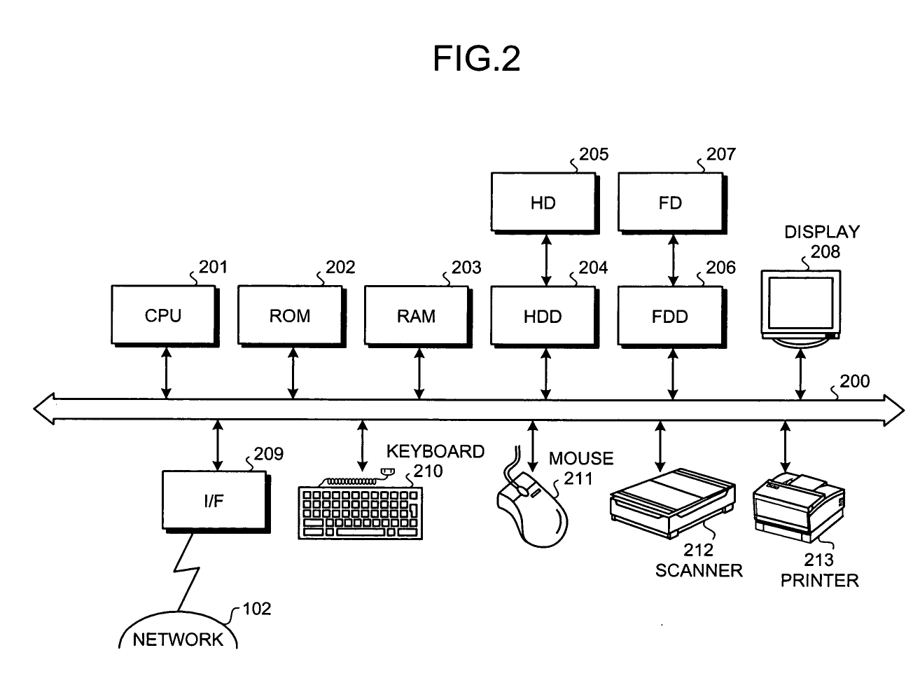

FIG. 2 is a schematic of a computer apparatus shown in FIG. 1. As shown in FIG. 2, the computer apparatus includes a central processing unit (CPU) 201, a read only memory (ROM) 202, a random access memory (RAM) 203, a hard disk drive (HDD) 204, a hard disk HD) 205, a flexible disk drive (FD) 206, a flexible disk (FD) 207 as an example of a removable recording medium, a display 208, an interface (I/F) 209, a keyboard 210, a mouse 211, a scanner 212, and a printer 213. These component units are connected to one another by way of a bus 220.

The CPU 201 performs overall control of the computer apparatus. The ROM 202 stores programs such as a boot program. The RAM 203 is used as a work area of the CPU 201. The HDD 204 controls reading and writing of data from or to the HD 205 under control of the CPU 201. The HD 205 stores the data written under control of the HDD 204.

The FDD 206 controls reading and writing of data from and to the FD 207 under control of the CPU 201. The FD 207 stores the data written under control of the FDD 206 and has the data stored in the FD 207 read by the computer apparatus.

A removable recording medium, besides the FD 207, may be a compact disc read-only memory (CD-ROM), a compact disc recordable (CD-R), a compact disc rewritable (CD-RW), a magneto optical (MO) disk, a digital versatile disk (DVD), or a memory card. The display 208 displays a cursor, an icon, a tool box, and data such as document, image, and function information. The display 208 may be, for example, a cathode ray tube, a thin-film-transistor liquid crystal display, or a plasma display.

The I/F 209 is connected to the network 102 such as the Internet through a telecommunication line and is connected to other devices through the network 102. The I/F 209 serves as an interface between the network 102 and the inside of the apparatus and controls the input and output of data from or to external devices. The I/F 209 may be, for example, a modem or a local area network (LAN) adaptor.

The keyboard 210 is equipped with keys for input of characters, numerals, and various instructions, and data is entered through the keyboard 210. The keyboard 210 may be a touch-panel input pad or a numeric keypad. The mouse 211 performs a cursor movement, a range selection, a movement or size change of a window. The mouse 211 may be a trackball or a joystick as long as a similar function as a pointing device is provided.

The scanner 212 optically reads an image and takes in the image data into the computer apparatus. The scanner 212 may have an OCR function as well. The printer 213 prints image data and document data. The printer 213 may be, for example, a laser printer or an ink jet printer.

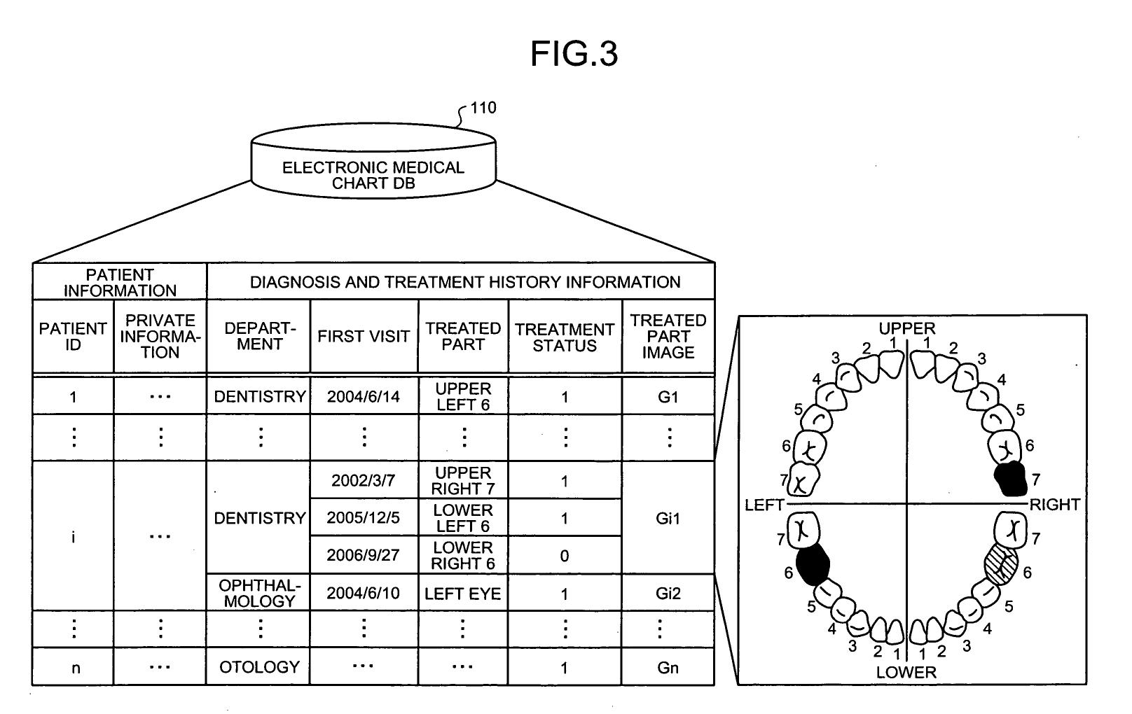

FIG. 3 is an explanatory diagram of contents stored in an electronic medical chart DB 110 shown in FIG. 1. As shown in FIG. 3, the electronic medical chart DB 110 stores the medical chart comprising patient information and diagnosis and treatment history information for each patient.

The patient information includes a patient ID and private information. The patient ID is identification information identifying the patient and is correlated to the private information and the diagnosis and treatment history information. The private information includes a name, contact information (address, phone number, e-mail address, etc.), an insurance card number, sex, age, blood type, etc., of the patient.

The information on contents of diagnosis and treatment is stored in the diagnosis and treatment history information. Specifically, a department consulted, a first consultation day, treated body part, treatment status, a treated part image, etc., are stored. The treatment status is a flag indicating whether the treatment is completed, and, for example, “1” indicates completion of the treatment and “0” indicates the treatment still ongoing.

Taking the example of the patient with the patient ID of i (i=1 to N) (hereinafter, “patient i”), the patient i had his/her teeth treated at the dentistry department on Mar. 7, 2002, Dec. 5, 2005, and Sep. 27, 2006. An upper right 7th tooth is treated in the diagnosis and treatment of Mar. 7, 2002, a lower left 6th tooth is treated in the diagnosis and treatment of Dec. 5, 2005, and a lower right 6th tooth was treated in the diagnosis and treatment of Sep. 27, 2006. The treatment of the upper right 7th tooth and the lower left 6th tooth is completed and the treatment of the lower right 6th tooth is still ongoing. A treated part image Gi1 shows the upper right 7th tooth and the lower left 6th tooth in black as to both of which the treatment is completed and the lower right 6th tooth is shown in hatching as the treatment is still ongoing. The patient i had his/her left eye treated at the ophthalmology department on Jun. 10, 2004.

While FIG. 3 does not specifically show contents of diagnosis by a doctor, it may be arranged such that the contents of diagnosis by a doctor are recorded in the electronic medical chart DB 110. In this case, when the electronic medical chart is sent to the communication terminal 103, the contents of diagnosis are also sent and disclosed as a part of the electronic medical chart.

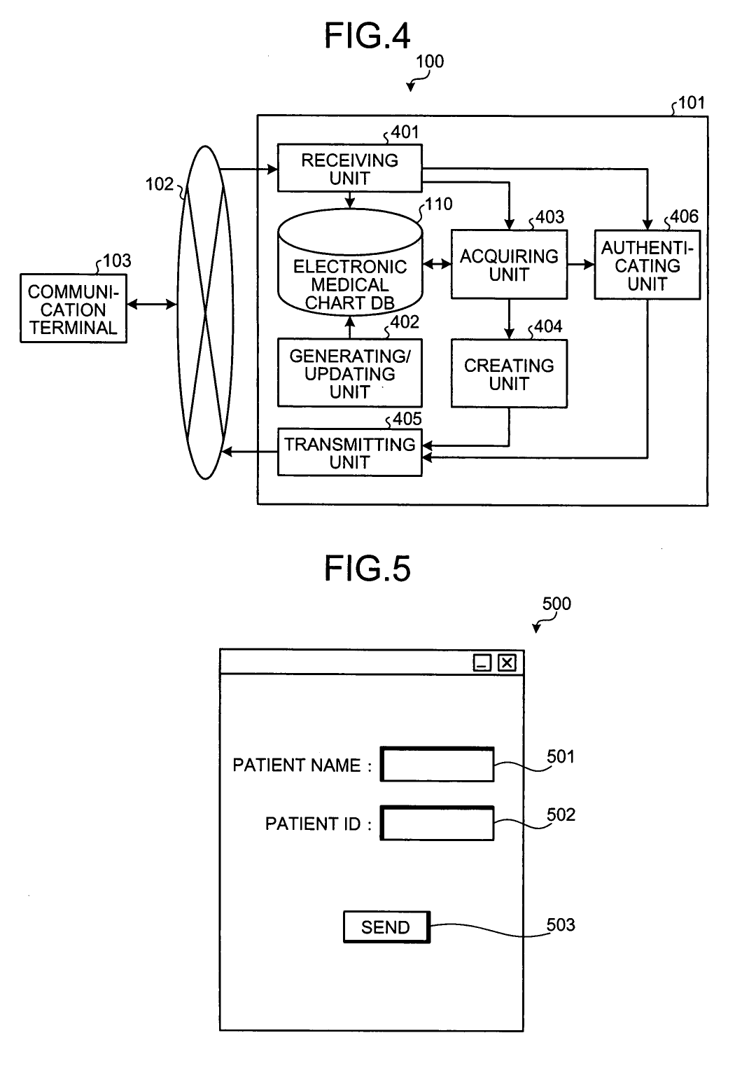

FIG. 4 is a block diagram of the information providing apparatus 101. As shown in FIG. 4, the information providing apparatus 101 includes the electronic medical chart DB 110, a receiving unit 401, a generating/updating unit 402, an acquiring unit 403, a creating unit 404, a transmitting unit 405, and an authenticating unit 406. These functional components 401 to 406 realize their functions by having the CPU 201 execute a program recorded on a recording medium such as HD 205 or by the I/F 209.

The receiving unit 401 has a function of receiving various types of information from the communication terminal 103. The information to be received includes, for example, a request for the electronic medical chart from the patient and input diagnosis and treatment contents identifying information that is input at the communication terminal 103. The request includes information of the patient ID and an IP address and individual identifying information that identify the communication terminal 103 sending the request.

The input diagnosis and treatment contents identifying information is input information identifying the contents of the diagnosis and treatment up to now of the patient input by the patient at the communication terminal 103 and is, for example, in the case of the patient i shown in FIG. 3, such input information as the upper right 7th and the lower left 6th as bodily parts treated, with respect to the dentistry department as a department consulted. This is the information that can be known only to the patient, besides the doctor. The information providing apparatus 101, upon receipt of the input diagnosis and treatment contents identifying information, authenticates the identify of the patient. The input diagnosis and treatment contents identifying information sent in response to inquiring information to be described later is referred to as “response information”.

The generating/updating unit 402 has a function of generating/updating the electronic medical chart of the patient by an input operation by the doctor. In the case of a new patient receiving the diagnosis and treatment for the first time, by recording the contents of the diagnosis and treatment of the patient, an electronic medical chart proper to the patient is generated. Thus generated electronic medical chart is stored in the electronic medical chart DB 110. In the case of updating the electronic medical chart, using the patient ID as a clue, the electronic medical chart of the patient is called up from the electronic medical chart DB 110, contents of the diagnosis and treatment are newly recorded, and thus updated electronic medical chart is stored in the electronic medical chart DB 110.

The acquiring unit 403 has a function of acquiring the information identifying the contents of the diagnosis and treatment (hereinafter, “diagnosis and treatment contents identifying information”) recorded in the electronic medical chart. Specifically, triggered by the receipt of the request for the electronic medical chart by the receiving unit 401, the acquiring unit 403 acquires the diagnosis and treatment contents identifying information. The diagnosis and treatment contents identifying information may be the contents themselves of the diagnosis and treatment or partial information extracted from the contents of the diagnosis and treatment. For example, in FIG. 3, taking the example of the patient i, all of the diagnosis and treatment history information of the patient may be taken as the diagnosis and treatment contents identifying information or the diagnosis and treatment history information of the patient i with respect to the dentistry department as a department consulted may be taken as the diagnosis and treatment contents identifying information.

The electronic medical chart from which to acquire the diagnosis and treatment contents identifying information is the latest electronic medical chart. Consequently, when the diagnosis and treatment history information of the patient i with respect to the dentistry department as a department consulted is taken as the diagnosis and treatment contents identifying information, if the request for the electronic medical chart is made on Aug. 1, 2006, then the diagnosis and treatment history information with respect to the upper right 7 and the lower left 6 as the bodily parts treated becomes the information to be acquired.

Thereafter, in the case of the request for the electronic medical chart being made on or after Sep. 28, 2006, since the lower right 6 as the treated body part has additionally been registered, the diagnosis and treatment history information with respect to the upper right 7, the lower left 6, and the lower right 6 as bodily parts treated becomes the information to be acquired. As seen above, the coverage of the information to be acquired as the diagnosis and treatment contents identifying information differs depending on an update status of the electronic medical chart.

This diagnosis and treatment contents identifying information is the information intended for a test of matching with the input diagnosis and treatment contents identifying information. Since this diagnosis and treatment contents identifying information is the information that can be known only to the patient and the diagnosis and treatment history information of the electronic medical chart is updated every time the patient receives a diagnosis/treatment, the diagnosis and treatment contents identifying information is of a special nature that, though it is the information proper to the patient, it changes. On the other hand, the diagnosis and treatment contents identifying information has an advantage that since the patient actually received the treatments, such information is naturally memorized by the patient and therefore is easy to remember, without the necessity of memorizing with an effort, for example, a password composed of complicated strings.

The creating unit 404 has a function of preparing inquiring information. The inquiring information is the information inquiring of the patient about the contents of diagnosis and treatment and specifically is the information prompting the selection of the bodily part as to which the patient received treatment in the past, the bodily part as to which the patient is now receiving treatment, and the diagnosed/treated bodily part at the department where the patient received the diagnosis and treatment in the past, the department where the patient is now receiving the diagnosis and treatment, etc. The inquiring information may be predetermined information or may be changed at random every time the request for the electronic medical chart is received. In the case of generating the inquiring information, the diagnosis and treatment contents identifying information described above is specifically referred to as “answer information”.

The inquiring information can be obtained such as “treated body part in the past and/or at present”, “treated body part in X times of past treatment”, and “treated body part in the past and/or at present at XX department”. The inquiring information may be the inquiring information covering a certain number of times or a certain period of time going back from the present time, such as “treated body part in X times of past treatment at XX department” and “treated body part for the past X months at XX department”. In such an arrangement, the answer information corresponding to the inquiring information changes with the update of the electronic medical chart and therefore, the answer information is prevented from being fixed.

The inquiring information may include the chronological order such as the order of diagnosis and treatment or the order of treatment as a condition. It is preferable that image information of the bodily part to be treated is included in this inquiring information, for easy inputting by the patient. For example, in the case of prompting the input of the treated body part at the dentistry department, the image information showing upper and lower rows of teeth may be sent.

The transmitting unit 405 has a function of sending various types of information obtained at the generating unit 403 and authenticating unit 406 to the communication terminal 103. For example, the transmitting unit 405 sends the inquiring information to the communication terminal 103. The inquiring information is displayed by the browser function of the communication terminal 103. The patient inputs the response information through the input key or touch-panel, guided by the information displayed. Thus input response information is received by the receiving unit 401.

The patient inputs the response information, remembering the past/present treated bodily part/department consulted. When the order of treatments/diagnoses and treatments is a criterion for authentication, the patient inputs the information in chronological order. For example, when the inquiring information is “bodily parts treated in the past three treatments at the dentistry department”, the patient i can prepare a time-series response information by inputting “upper right 7→lower left 6→lower right 6”. Likewise, when the inquiring information is “departments consulted in the past four consultations”, the patient i can prepare a time-series response information by inputting “dentistry department→opthalmology department→dentistry department→dentistry department”.

When authenticating processing is executed by the authenticating unit 406, the transmitting unit 405 sends the information corresponding to the result of the authentication. For example, if the authentication fails, then the transmitting unit 405 sends screen information indicating authentication failure. On the other hand, if the authentication succeeds, then the transmitting unit 405 sends the electronic medical chart of the patient.

The authenticating unit 406 has a function of authenticating the identity of the patient. Specifically, when the input diagnosis and treatment contents identifying information (or response information) sent from the communication terminal 103 matches with the diagnosis and treatment contents identifying information (or answer information) acquired from the electronic medical chart of the patient, it means that the patient is authenticated and when these two types of information do not match, it means that the patient is not authenticated.

For example, when the inquiring information of “bodily parts treated in past two treatments at the dentistry department” is sent to the communication terminal 103 of the patient i, the answer information is “upper right 7→lower left 6” since, according to the diagnosis and treatment history information in the electronic medical chart of the patient i, the upper right 7th tooth was treated in the diagnosis and treatment of Mar. 7, 2002 and the lower left 6th tooth was treated in the diagnosis and treatment of Dec. 5, 2005. In this case, if the response information from the communication terminal 103 of the patient i is “upper right 7→lower left 6”, then the patient is authenticated.

In this case, if the response information of “upper left 7→lower right 7” is received from the communication terminal 103 of the patient i, then the patient is not authenticated since the response information does not match with the answer information of “upper right 7→lower left 6”. In the case where the above inquiring information specifies the chronological order (e.g., from oldest to newest) as a condition, when the response information of “lower left 6→upper right 7” is received from the communication terminal 103 of the patient i, the patient is not authenticated since the information does not match with the answer information of “upper right 7→lower left 6”. When the condition specified above is not applicable, the response information matches with the answer information and the patient is authenticated.

A notation of “X→ . . . →Y→ . . . →Z” indicates that X is the oldest in time and Z is the latest in time. Each of X, Y, and Z represents the department consulted/treated body part.

FIG. 5 is a schematic illustrating an example of the request screen for an electronic medical chart. As shown in FIG. 5, the acquiring request screen 500 displays a space 501 for inputting a patient name, a space 502 for inputting a patient ID, and a send button 503. By inputting the patient name and the patient ID at their respective inputting spaces 501 and 502, using an input key or a mouse of the communication terminal 103, and by clicking the send button 503, the patient can have the acquiring request including the patient name and the patient ID transmitted to the information providing apparatus 101.

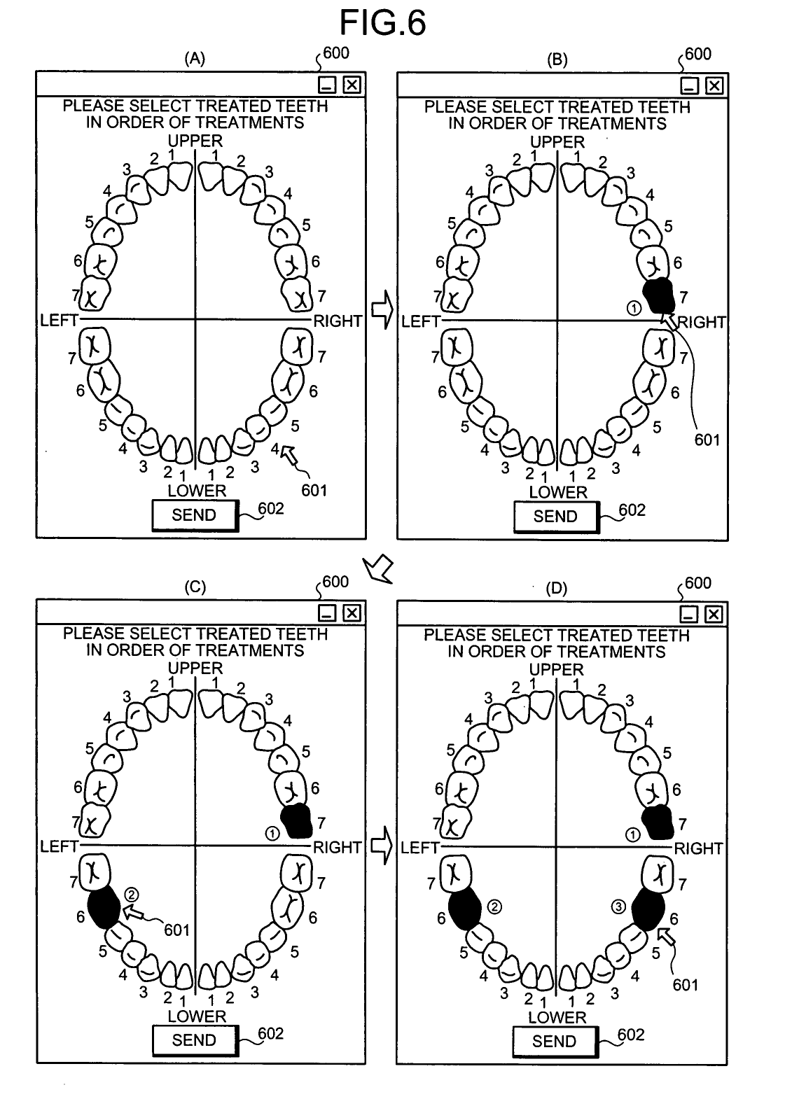

FIG. 6 is a schematic illustrating an example of the display screen of the inquiring information at the communication terminal 103. The display screen 600 of the inquiring information displays rows of teeth as image information of the bodily part to be treated. The inquiring information is assumed to be “body part treated in past and at present at the dentistry department in chronological order”. The patient inputs selection in the order of A to D shown in FIG. 6. Diagram A depicts the screen before selection, diagram B depicts the screen when the patient has selected the treated body part in the oldest treatment, the diagram C depicts the screen when the patient has selected the treated body part in the second oldest treatment, and diagram D depicts the screen when the patient has selected the part being treated at present.

By moving the cursor 601 and selecting the upper right 7th tooth in the state of diagram A, the state changes to the state of diagram B. In diagram B, the selected tooth is reversely displayed in black. Encircled figures represent the order of selection made.

Next, by moving the cursor 601 and selecting the lower left 6th tooth in the state of diagram B, the state changes to the state of diagram C. Lastly, by moving the cursor 601 and selecting the lower right 6th tooth in the state of diagram C, the state changes to the state of diagram D. Thereafter, by clicking the send button 602, the response information of “upper right 7→lower left 6→lower right 6” indicating the selected teeth and the order of the selection thereof is sent to the information providing apparatus 101.

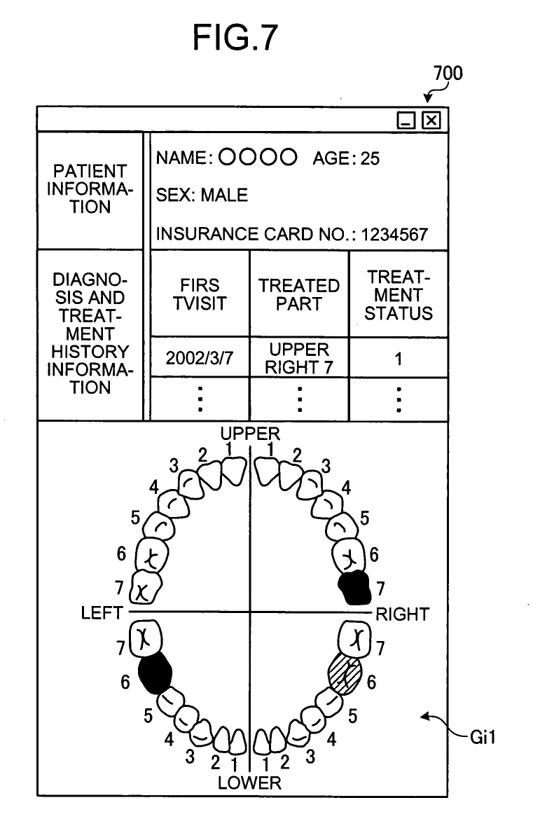

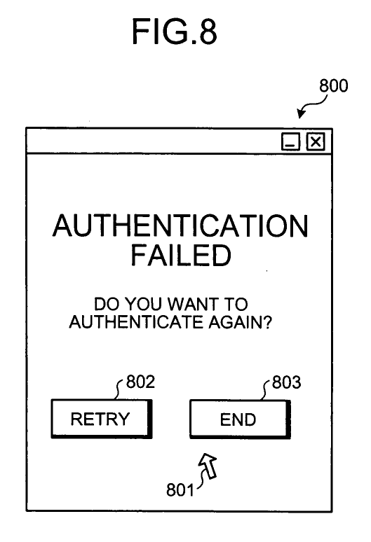

FIG. 7 is schematic illustrating an example of the electronic medical chart displayed on the communication terminal 103 when the patient is authenticated. FIG. 7 shows the electronic medical chart 700 of the patient i. The patient information, the diagnosis and treatment history information, and the treated part image Gi1 of the patient i are displayed in the electronic medical chart 700. FIG. 8 is a schematic illustrating an example of the authentication failure information screen displayed on the communication terminal when the patient is not authenticated. In the authentication failure information screen 800, by moving the cursor 801 and clicking the retry button 802, the inquiring information is resent from the information providing apparatus 101 and by clicking the end button 803, the information providing service is finished.

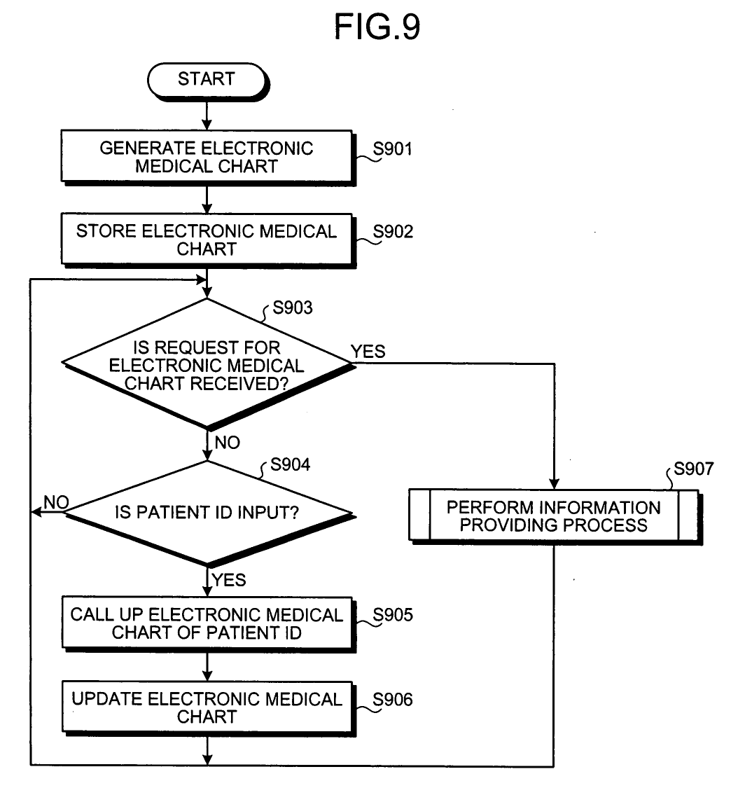

FIG. 9 is a flowchart of the electronic medical chart generating/updating process according to the embodiments of the present invention. As shown in FIG. 9, first, the electronic medical chart is generated by the generating/updating unit 402 (step S901). Next, thus generated electronic medical chart is stored in the electronic medical chart DB 110 (step S902).

Thereafter, it is determined whether a request for the electronic medical chart is received from the communication terminal of the patient (step S903). If the request is not received (step S903: NO), then it is determined whether the patient ID is input (step S904). If the patient ID is not input (step S904: NO), then the flow goes back to step S903.

On the other hand, if the patient ID is input (step S904: YES), the electronic medical chart of the patient is called up from the electronic medical chart DB 110 (step S905). Then, by inputting contents of new diagnosis and treatment, the electronic medical chart is updated (step S906). Thereafter, the flow goes back to step S903.

On the other hand, at step S903, if the request for the electronic medical chart is received (step S903: YES), then information providing processing is executed (step S907). After this information providing processing, the flow goes to step S903.

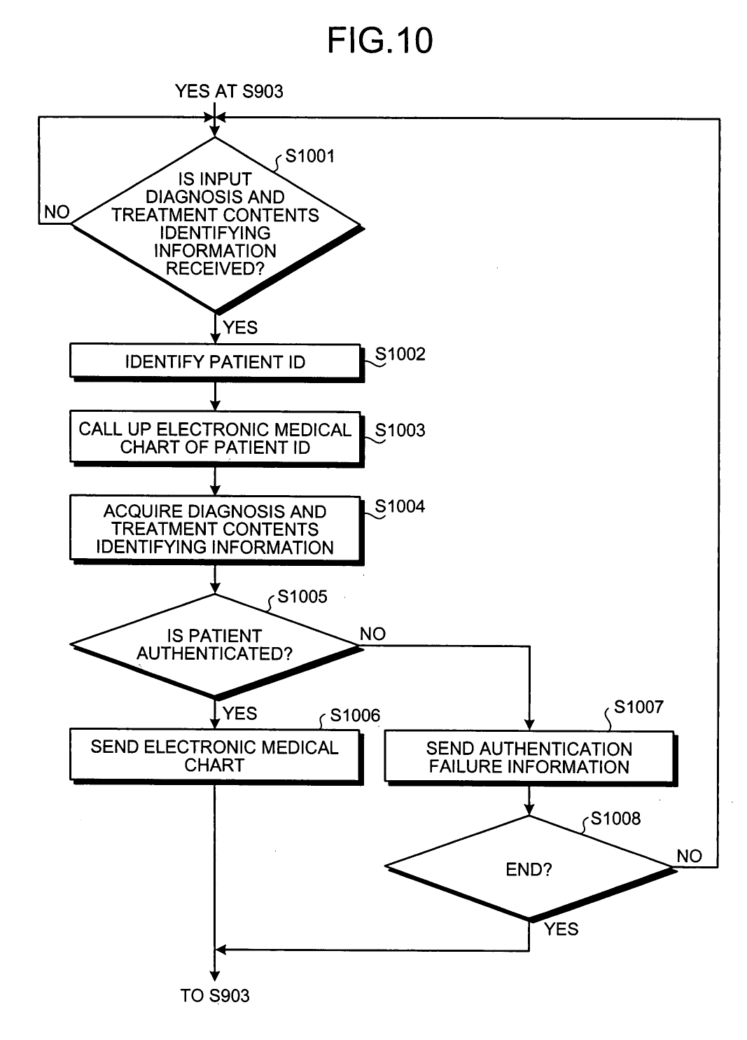

FIG. 10 is a flowchart of the information providing process according to the embodiments of the present invention. As shown in FIG. 10, after YES at step S903, reception is awaited of the input diagnosis and treatment contents identifying information from the communication terminal of the patient (step S1001: NO) and if the information is received (step S1001: YES), then the patient ID is identified (step S1002). Here, it is assumed that the patient i has been identified.

Then, the electronic medical chart of the patient i is called up from the electronic medical chart DB 110 (step S1003) and the diagnosis and treatment contents identifying information is acquired from the called-up electronic medical chart (step S1004). Thereafter, it is determined whether the patient is authenticated, by checking the matching between the input diagnosis and treatment contents identifying information and the diagnosis and treatment contents identifying information (step S1005). If the patient is authenticated (step S1005: YES), then latest electronic medical chart of the patient is sent to the communication terminal 103 of the patient (step S1006).

On the other hand, if the patient is not authenticated (step S1005: NO), namely, in the case of mismatch, the flow goes to step S1007. At step S1007, the transmitting unit 405 sends the authentication failure information to the communication terminal 103 from which the request is sent. The authentication failure information screen 800 shown in FIG. 8 is then displayed on the communication terminal 103. Then, it is determined whether the processing is finished (step S1008). Specifically, if the retry button 802 is clicked (step S1008: NO), then the flow goes back to step S1001, and if the end button 803 is clicked (step S1008: YES), then the flow goes back to step S903.

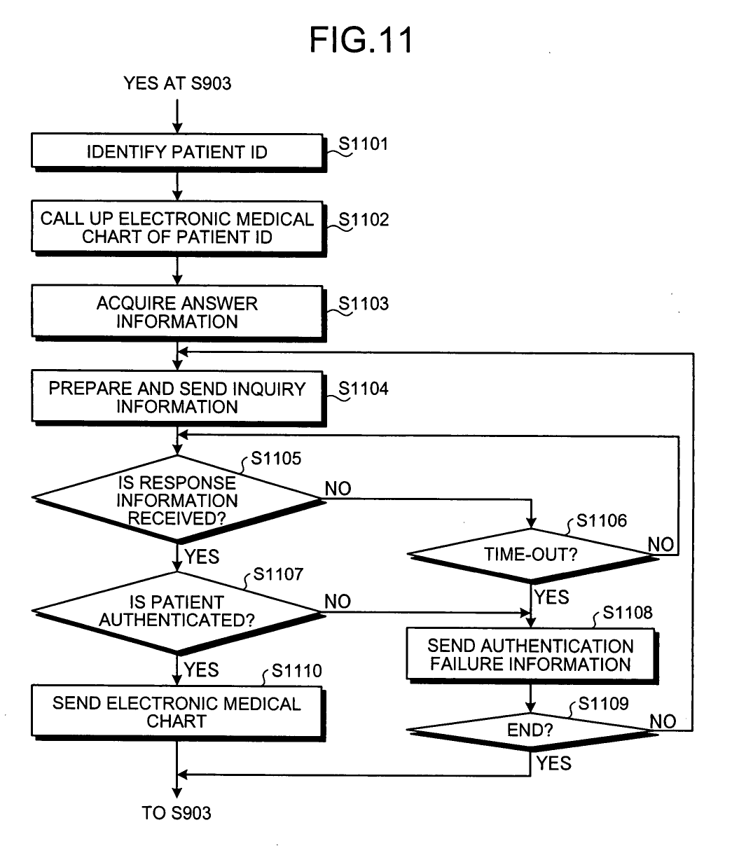

FIG. 11 is a flowchart of a procedure of the information providing processing according to the embodiments of the present invention. In FIG. 11, after YES at step S903, the patient ID is identified (step S1101). Here, it is assumed that the patient i has been identified.

Next, the electronic medical chart of the patient i is called up from the electronic medical chart DB 110 (step S1102) and the answer information is acquired based on the electronic medical chart (step S1103). Thereafter, the inquiring information is prepared and sent to the communication terminal 103 from which the request is sent (step S1104).

Thereafter, it is determined whether the response information is received from the communication terminal 103 (step S1105). If the response information is not received (step S1105: NO), then it is determined whether a time-out has occurred (step S1106). If the time-out has not occurred (step S1106: NO), then the flow goes back to step S1105. On the other hand, if the time-out has occurred (step S1106: YES), then the flow goes to step S1108.

At step S1105, if the response information is received (step S1105: YES), then the authenticating processing is performed by the authenticating unit 406 (step S1107). Namely, it is determined whether the response information received at step S1105 matches with the answer information acquired at step S1103.

If the patient is not authenticated (step S1107: NO), namely, if these two kinds of information do not match, then the flow goes to step S1108. At step S1108, the transmitting unit 405 sends the authentication failure information to the communication terminal 103. The authentication failure information screen 800 is then displayed on the communication terminal 103.

Then, it is determined whether it is the end of the process (step S1109). Specifically, if the retry button 802 is clicked (step S1109: NO), the flow goes back to step S1104, and if the end button is clicked (step S1109: YES), then the flow goes back to step S903.

At step S1107, if the patient is authenticated (step S1107: YES), namely, if the answer information and the response information match, the latest electronic medical chart called up at step S1102 is sent to the communication terminal from which the request is sent (step S1110). With this, a sequence of processing is finished.

As seen above, according to the present embodiments, two different kinds of answer information are generated for the same patient depending on whether the answer information is generated before or after the update of the electronic medical chart. Therefore, addition of the body part newly diagnosed and treated is the information that can be known only to the patient and in view of the fact that the answer information changes in accordance with such kind of information, the electronic medical chart can safely be disclosed only to the authentic patient.

Since the bodily parts treated and the order of the treatments thereof are the information known only to the patient who have actually undergone such treatments, the generation of the answer information using such information as a key can achieve an improvement of the security quality of the answer information. Especially when the bodily parts treated is inside the body, the information on such treatment is not known from the external appearance of the patient and therefore, such generation of the answer information is effective.

Likewise, since the departments consulted and the order of the diagnoses and treatments are the information known only to the patient that has actually undergone such diagnoses and treatments, the generation of the answer information using such information as a key can achieve an improvement of the security quality of the answer information. Especially when a plurality of departments are consulted or when the same department is consulted for a number of times, the information on the diagnoses and treatments becomes more difficult to know and therefore, such generation of the answer information is effective.

As seen above, since the answer information is the information that can be known only to the patient and the diagnosis and treatment history information of the electronic medical chart is updated every time the patient receives a diagnosis/treatment, the answer information is of a special nature that, though it is the information proper to the patient, it changes. On the other hand, the answer information has an advantage that since the patient actually received the treatments, such information is naturally stored in the patient's brain and therefore is easy to remember, without the necessity of memorizing with an effort, for example, a password composed of complicated strings.

Since the present embodiments do not require the communication terminal of the patient to be equipped with a high-cost device such as a biometric data acquiring device and enable any general-purpose computer device such as a cellular phone having at least the browsing function to receive the electronic medical chart providing service, the penetration rate of the electronic medical chart providing service can be improved.

In the system of authenticating by the biometric data, in the case of leakage of biometric data, since the same kind of biometric data can possibly be put to bad use, the system is forced to switch to different biometric data and the operational cost of the system is increased. On the other hand, the present embodiments in which the answer information changes in accordance with the update of the electronic medical chart can sufficiently counter the information leakage and can achieve improved safety while restraining an increase in the operational cost.

While in the embodiments described above, the information providing apparatus 101 has been described as a server installed in a specific medical institution, the information providing apparatus 101 can be installed in a service center that consolidates electronic medical charts of a plurality of medical institutions and provides the electronic medical charts to patients. In this case, the information providing apparatus 101 is not required to have a function of generating and updating the electronic medical charts (generating/updating unit 402), but instead updates the electronic medical chart DB 110 by receiving the latest electronic medical chart (or only a updated part thereof) from servers of medical institutions every time the electronic medical chart is updated.

As described above, the information providing program, the recording medium with the program recorded thereon, the information providing apparatus, and the information providing method according to the present invention have the effect of achieving the low cost and an improvement of safety control.

The information providing method described in the embodiments of the present invention can be realized by executing a program prepared in advance on a computer such as a personal computer and a workstation. This program is recorded on a computer-readable recording medium such as a hard disk, a flexible disk, a CD-ROM, an MO, and a DVD and is executed by being read out from the recording medium by a computer. This program may be in the form of a transmission medium that can be distributed through a network such as the Internet.

According to the above embodiments, it is possible to lower a cost and to improve safety control.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein an information providing program causing a computer to execute:
updating an electronic medical chart of a patient;
acquiring information identifying contents of diagnosis and treatment recorded on the updated electronic medical chart;
authenticating the patient based on the acquired information and information identifying contents of diagnosis and treatment that is sent from a communication terminal of the patient; and
sending the updated electronic medical chart to the communication terminal when the patient is authenticated at the authenticating.

2. The computer-readable recording medium according to claim 1, wherein the acquiring includes acquiring the information corresponding to diagnosis and treatment of last predetermined times or for a predetermined period of time going back from a present time.

3. The computer-readable recording medium according to claim 1, wherein
the acquired information and the information from the communication terminal indicate a part of body on which the diagnosis and treatment are performed, and
the information from the communication terminal is input by the patient.

4. The computer-readable recording medium according to claim 1, wherein
the acquired information and the information from the communication terminal indicate parts of body on which the diagnosis and treatment are performed and an order in which the diagnosis and treatment are performed on the parts, and
the information from the communication terminal is input by the patient.

5. The computer-readable recording medium according to claim 1, wherein
the acquired information and the information from the communication terminal indicate a department at which the diagnosis and treatment are performed, and
the information from the communication terminal is input by the patient.

6. The computer-readable recording medium according to claim 1, wherein
the acquired information and the information from the communication terminal indicate departments at which the diagnosis and treatment are performed and an order of the departments in which the diagnosis and treatment are performed, and
the information from the communication terminal is input by the patient.

7. The computer-readable recording medium according to claim 1, wherein the information providing program further causes the computer to execute:
sending, to the communication terminal, inquiry for the information identifying contents of diagnosis and treatment; and
receiving the information identifying contents of diagnosis and treatment from the communication terminal as a response to the inquiry, wherein
the authenticating includes authenticating the patient based on the response and answer information identifying contents of diagnosis and treatment.

8. The computer-readable recording medium according to claim 7, wherein
the inquiry is about a part of body on which the diagnosis and treatment are performed,
the answer information is information identifying a part of body on which the diagnosis and treatment are performed, and
the response is information identifying a part of body on which the diagnosis and treatment is performed, the response input by the patient in response to the inquiry.

9. The computer-readable recording medium according to claim 7, wherein
the inquiry is about parts of body on which the diagnosis and treatment are performed and an order in which the diagnosis and treatment are performed,
the answer information is information identifying parts of body on which the diagnosis and treatment are performed and an order of the parts in which the diagnosis and treatment are performed, and
the response is information identifying parts of body on which diagnosis and treatment are performed, the response input by the patient in response to the inquiry.

10. The computer-readable recording medium according to claim 7, wherein
the inquiry is about a department, and
the answer information is information identifying a department at which the diagnosis and treatment are performed, and
the response is information identifying a department at which diagnosis and treatment are performed, the response input by the patient in response to the inquiry.

11. The information providing program of claim 7, wherein
the inquiry is about departments and an order of the department in which the diagnosis and treatment are performed,
the answer information is information identifying departments at which the diagnosis and treatment are performed and an order of the departments in which the diagnosis and treatment are performed, and
the response is information identifying departments and an order of departments in which the diagnosis and treatment are performed, the response input by the patient in response to the inquiry.

12. An information providing apparatus comprising:
an updating unit that updates an electronic medical chart of a patient;
an acquiring unit that acquires information identifying contents of diagnosis and treatment recorded on the updated electronic medical chart;
an authenticating unit that authenticates the patient based on the acquired information and information identifying contents of diagnosis and treatment that is sent from a communication terminal of the patient; and
a sending unit that sends the updated electronic medical chart to the communication terminal when the patient is authenticated at the authenticating.

13. An information providing method comprising:
updating an electronic medical chart of a patient;
acquiring information identifying contents of diagnosis and treatment recorded on the updated electronic medical chart;
authenticating the patient based on the acquired information and information identifying contents of diagnosis and treatment that is sent from a communication terminal of the patient; and
sending the updated electronic medical chart to the communication terminal when the patient is authenticated at the authenticating.
